(19) United States
(12) Patent Application Publication
(10) Pub. No.: US 2007/0279540 A1
(43) Pub. Date: Dec. 6, 2007

(54) ACTIVE MATRIX SUBSTRATE, LIQUID CRYSTAL DISPLAY, LIQUID CRYSTAL PROJECTOR AND REAR PROJECTION APPARATUS

(75) Inventors: Sakae Hashimoto, Machida-shi (JP); Asako Ura, Atsugi-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/754,480

(22) Filed: May 29, 2007

(30) Foreign Application Priority Data
May 31, 2006 (JP) 2006-151778
May 28, 2007 (JP) 2007-140427

(51) Int. Cl. G02F 1/1335; G02F 1/1343

(52) U.S. Cl. 349/5; 349/139; 349/113

(57) ABSTRACT

An active matrix substrate for use in liquid crystal displays for use in liquid crystal displays comprises a lamination structure in which a plurality of interlayer insulating films and a plurality of electroconductive layers are alternately stacked; and a pixel region having a plurality of pixels arranged over a top layer of the interlayer insulating films. In this arrangement, the top layer among the plurality of interlayer insulating films is planarized. And, the plurality of pixel electrodes have a gap therebetween. The film thickness of the pixel electrodes is not less than 50 nm but not more than 200 nm, and the distance T between the surface of the pixel electrodes and the surface of the gap between the pixel electrodes is smaller than the width S of the gap between the pixel electrodes.

### BACKGROUND OF THE INVENTION

1. Field of the Invention

The present invention relates to an active matrix substrate, a liquid crystal display, a liquid crystal projector system and a method for fabricating active matrix substrates, and more particularly to an active matrix substrate, a liquid crystal display, a liquid crystal projector system and a method for fabricating active matrix substrates which are free from sticking (image memory phenomenon) and stable in orientation and provide high contrast display images.

2. Description of the Related Art

Along with the accelerated advancement of projection displays in fineness and luminance over the recent years, reflective liquid crystal display elements higher in the efficiency of light utilization than transmissive liquid crystal display elements are now coming into practical use.

FIG. 14 shows the sectional structure of a reflective liquid crystal element described in Japanese Patent Application Laid-Open No. 2001-242485. As shown in FIG. 14, in a conventional reflective liquid crystal element, an MOS transistor comprising a gate electrode 13a, sources 12a and drains 12b is formed over a silicon substrate 11. Interlayer insulating films 14, 15, 18 and 19, intermediate wiring layers 17a, data bus lines 17b and connection plugs 16a and 20a are formed over the transistor. After the surface of the interlayer insulating film 19 is treated by chemical mechanical polishing (CMP), pixel electrodes 21 are formed. After that, a silicon nitride film is formed as a cover film 22 over the pixel electrodes 21. Next, the cover film 22 is coated with SOG to fill the gaps between the pixel electrodes 21 with a SOG film 23. Then, the SOG film 23 is treated by CMP with the cover film 22 as stopper to planarize the surface.

By this fabricating method, the interlayer insulating films 15 and 19 are planarized by CMP treatment, and a surface oxidation preventing film is formed as a plane with the cover film over the pixel electrode as the polishing stop layer. In this way, a reflective liquid crystal element the surface of whose top layer is polarized can be provided. Where the surface of the top layer is polarized, unevenness of gaps from the opposite electrode can be restrained, and the thickness of the liquid crystal layer formed by injection between the silicon substrate and the opposite electrode can be more easily uniformized. By the related art stated here, the silicon nitride film is used as the cover film 22 of the electrode function as CMP stopper in planarizing the surface.

### SUMMARY OF THE INVENTION

However, in the CMP treatment described in Japanese Patent Application Laid-Open No. 2001-242485, the selection ratio of the polishing speed of the SOG film 23 and the cover film 22, which is a silicon nitride film, is not sufficiently high, and the thickness of the silicon nitride film, which serves as the cover film, remaining after the CMP treatment becomes more uneven. The uneven thickness of the cover film 22 invites interference, which might result in a decrease in luminance.

The prevention invention is intended to address this problem.

The active matrix substrate for use in liquid crystal displays according to the invention comprises a lamination structure in which a plurality of interlayer insulating films and a plurality of electroconductive layers are alternately stacked, wherein a top layer among the plurality of interlayer insulating films is planarized; and a pixel region having a plurality of pixels arranged over the top layer of the interlayer insulating films, wherein the plurality of pixel electrodes have a gap in-between; wherein the film thickness of the pixel electrodes is not less than 50 nm but not more than 200 nm, and the distance T between the surface over the pixel electrodes and the surface of the gap between the pixel electrodes is smaller than the width S of the gap between the pixel electrodes.

Further features of the present invention will become apparent from the following description of exemplary embodiments with reference to the attached drawings.

### BRIEF DESCRIPTION OF THE DRAWINGS

FIG. 1 is a sectional view of a reflective liquid crystal element as an exemplary embodiment of the present invention.

FIG. 2 is a sectional view showing details of pixel electrodes 117 and a liquid crystal layer 121.

FIG. 3 is a sectional view showing an early stage of a method for fabricating the reflective liquid crystal display element as the first exemplary embodiment of the invention.

FIG. 4 is a sectional view showing the next stage of the method for fabricating the reflective liquid crystal display element as the first exemplary embodiment of the invention.

FIG. 5 is a sectional view showing a further stage of the method for fabricating the reflective liquid crystal display element as the first exemplary embodiment of the invention.

FIG. 6 is a sectional view showing a still further stage of the method for fabricating the reflective liquid crystal display element as the first exemplary embodiment of the invention.

FIGS. 7A, 7B and 7C are sectional views showing a yet further stage of the method for fabricating the reflective liquid crystal display element as the first exemplary embodiment of the invention.

FIG. 8 is a sectional view showing the final stage of the method for fabricating the reflective liquid crystal display element as the first exemplary embodiment of the invention.

FIG. 9 is a sectional view showing the pad part of the reflective liquid crystal display element according to the invention.

FIGS. 10A, 10B, 10C, 10D and 10E are sectional views showing a method for fabricating the reflective liquid crystal display element as a second exemplary embodiment of the invention.

FIGS. 11A, 11B, 11C, 11D and 11E are sectional views showing a method for fabricating the reflective liquid crystal display element as a third exemplary embodiment of the invention.

FIG. 12 is a block diagram showing one example of optical system for liquid crystal projectors as a fourth exemplary embodiment of the invention.

FIG. 13 is a block diagram showing one example of rear projector apparatus as a fifth exemplary embodiment of the invention.

FIG. 14 shows the sectional structure of a conventional reflective liquid crystal element.

### DESCRIPTION OF THE EMBODIMENTS

Exemplary embodiments of the present invention will be described below with reference to accompanying drawings.

### First Exemplary Embodiment

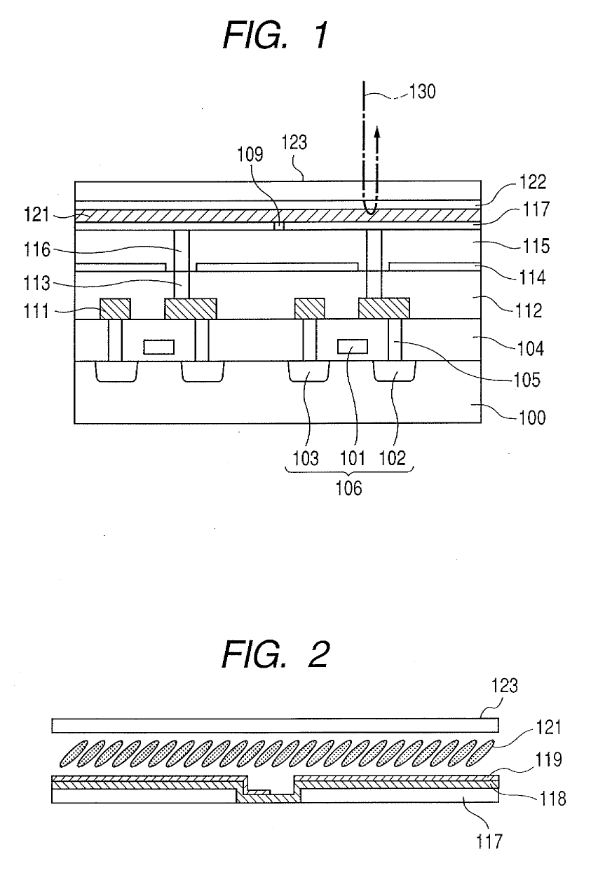

FIG. 1 is a sectional view of a reflective liquid crystal element as an exemplary embodiment of the invention. Referring to FIG. 1, reference numeral 100 designates a monocrystalline semiconductor substrate such as a first electroconductive type monocrystalline silicon substrate; 101, gate electrodes of polysilicon or the like; 102, sources into which an impurity of a second electroconductive type, reverse to the first electroconductive type, is implanted; and 103, drains into which an impurity of the second electroconductive type like the source 102 is implanted; each MOS transistor 106, which is a switching element, is formed comprising these gate electrode 101, source 102 and drain 103. Reference numeral 104 designates a first interlayer insulating film disposed over the transistor 106; 105, first connecting holes arranged in the first interlayer insulating film 104; 111, a first electroconductive layer arranged over the first electroconductive layer 104; 112, a second interlayer insulating film arranged over the first electroconductive layer; 113, second connecting holes arranged in the second interlayer insulating film 112; 114, a light shielding layer formed of a second electroconductive layer and arranged over the second interlayer insulating film 112; 115, a third interlayer insulating film arranged over the light shielding layer; 116, third connecting holes arranged in the third interlayer insulating film 115; and 117, pixel electrodes formed of the top electroconductive layer arranged over the third interlayer insulating film 115 and each matching a pixel. Here, in the layers below the pixel electrodes 117, a plurality of electroconductive layers and a plurality of interlayer insulating films are alternately stacked and, out of the interlayer insulating films below the pixel electrodes 117, at least the third interlayer insulating film 115, which is the top layer of the interlayer insulating layers, is planarized by CMP treatment or otherwise. These pixel electrodes 117 are arranged over the silicon substrate 100 in a matrix to constitute a pixel region. The sources 102 are electrically connected to the pixel electrodes 117 via the first connecting holes 105, the first wiring layer 111, the second connecting holes 113 and the third connecting holes 116. For this reason, the pixel electrodes 117 have a function to reflect incident light 130 from the opposite electrode substrate 123 side and a function to selectively apply a driving voltage to a liquid crystal layer 121. The reflectivity of these pixel electrodes 117 is relatively high, 90% or above in the visible light range, and are made of a usual metallic wiring material for LSI, such as pure aluminum or aluminum with addition of silicon or copper in a few weight %. In order to prevent the incident light invading from the inter-pixel region 109 between adjoining pixel electrodes 117 from the MOS transistor 106, the light shielding layer 114 is formed.

FIG. 2 is a sectional view showing details of the pixel electrodes 117 and the liquid crystal layer 121.

Referring to FIG. 2, an insulating film 118 is formed over the pixel electrodes 117, and an oblique vapor deposition film 119 is formed above the plurality of pixel electrodes 117. According to the invention, an active matrix substrate is configured encompassing elements from the silicon substrate 100 to the oblique vapor deposition film 119. In this exemplary embodiment, the film thickness of the pixel electrodes 117 ranges from 50 nm to 200 nm, and that of the insulating film 118 formed over the pixel electrodes 117, from 5 nm to 40 nm.

First the range of the insulating film 118 is prescribed for the following reasons.

It is difficult to form a uniformly thick insulating film 118 by plasma CVD at a film thickness of 5 nm or less. Whereas the oblique vapor deposition film of the same material is formed over the insulating film 118, the formation of the oblique vapor deposition film is also difficult where the film thickness of the insulating film 118 is 5 nm or less. If the insulating film 118 is too thick, liquid crystals may become burned. This sticking (image memory phenomenon) of liquid crystals is particularly conspicuous in a reflective liquid crystal display in which pixel electrodes are formed of a different from the opposite electrode, such as ITO. Since the reflective pixel electrodes 117 are formed of a different from the opposite electrode, the work function differs between opposing electrodes, and a D.C. voltage is applied between the electrodes. This invites application of a D.C. voltage between liquid crystal molecules, which gives rise to sticking (image memory phenomenon). Here, the insulating film 118 is formed covering the surface of the pixel electrodes, and electric charges of one polarity deriving from the D.C. voltage accumulate on the interface between the insulating film 118 and the liquid crystals. It has been found that by reducing the thickness of the insulating film 118 to 40 nm or below the electric charges can be passed to the pixel electrodes 117 without allowing them to accumulate in the insulating film 118. Therefore, according to what the present inventors have found by verification, the thickness of the insulating film 118 should preferably be not less than 5 nm but not more than 40 nm.

Then, the range of the film thickness of the pixel electrodes 117 is prescribed for the following reasons.

(1) Reflectivity: The absolute reflectivity of Al-based materials reaches a level of 91% at or below 50 nm, and no longer rises even if the thickness is increased (when the electrodes are fabricated by sputtering, increase unevenness of the surface will rather result in a slight decrease in reflectivity). This results in a 50 nm or greater film thickness of the pixel electrodes 117.

(2) Transmissivity: As indicated by the following equation, at 50 nm, 100 nm or 200 nm in the film thickness of the pixel electrodes 117, the transmissivity is 3E-3, 1E-5 or 1E-10, respectively.

I=I₀ exp(−αx) (where x is the film thickness, α=4πk/λ, and k is the absorption coefficient)

According to the equation above, since the transmissivity decreases with the film thickness and therefore the performance is improved, the upper limit has no critical significance (if there is not risk of light leak, the thinner, the more advantageous for orientation).

(3) Orientation: In order to prevent imperfect orientation without the polarization process, there is no need to make the reflective electrodes thicker than is absolutely required. It is preferable for the thickness T of the pixel electrodes 117 (distance between the surface of the pixel electrodes 117 and the surface of the underlying layer exposed in the gap between the pixel electrodes) is smaller than the width S of the gap between the pixel electrodes 117. The inter-pixel gap S (the gap between reflective electrodes: 0.3 μm, effective width (the gap between reflective electrodes—2×insulating film): 0.22 μm) is, because of its relationship with the formula of the step T of the pixel electrodes (substantially equal to the thickness of the pixel electrodes), 0.22 μm. More preferably, in the oblique vapor deposition process with a 35° inclination in the normal direction of the substrate, 50% or more of the gap between the pixel electrodes should be covered with an oblique vapor deposition film.

0.22×½×sin 35°≦0.22 μm (200 nm) (upper limit)

The preferable material for the insulating film 118 is any of silicon oxide, silicon nitride, silicon oxynitride and alumina, which are used for film formation in the semiconductor process and do not absorb light. Especially, as a material equal to the orientation film of oblique vapor deposition is preferable from the viewpoint of refractive index matching and the oblique vapor deposition uses silicon oxide, this material is more preferable.

Also, it is preferable for the thickness T of the pixel electrodes 117 (distance between the surface of the pixel electrodes 117 and the surface of the underlying layer exposed in the gap between the pixel electrodes) is smaller than the width S of the gap between the pixel electrodes 117. The reason is that, according to what the present inventors have found by verification, imperfect orientation can be restrained by covering 50% or more of the gap between the pixel electrodes with an oblique vapor deposition film.

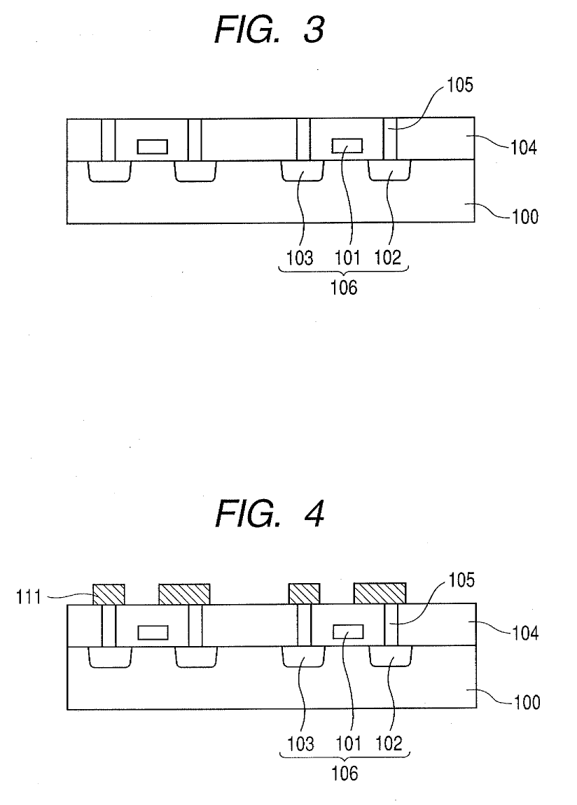

Next, the method for fabricating the reflective liquid crystal display element shown in FIG. 1 will be described with reference to FIG. 3 through FIG. 8.

As shown in FIG. 3, the gate electrode 101 is formed over the silicon substrate 100 of the first electroconductive type with an insulating film in-between, and a source 102 and a drain 103 are formed on the two sides of the gate electrode 101 by implanting impurities of the second electroconductive type by ion implantation or otherwise. Next, the first interlayer insulating film 104 made of nondoped silica glass (NSG), boron-doped phosphosilicate glass (BPSG) or a like material is formed. This is a film formation step using reduced pressure CVD, normal pressure CVD or the like and a planarization step using resist etch-back, CMP or the like. Further, the first connecting holes 105 are bored by photolithography and dry etching. The first connecting holes 105 are formed by further performing a step of films of barrier metal, such as titanium (Ti), titanium nitride (TiN) or the like, and tungsten (W) and by a W etch-back or W-CMP step.

Next, as shown in FIG. 4, an aluminum metal film is formed of pure aluminum or aluminum with addition of silicon or copper in a few weight % by sputtering and otherwise, followed by photolithography and dry etching to form the first electroconductive layer 111.

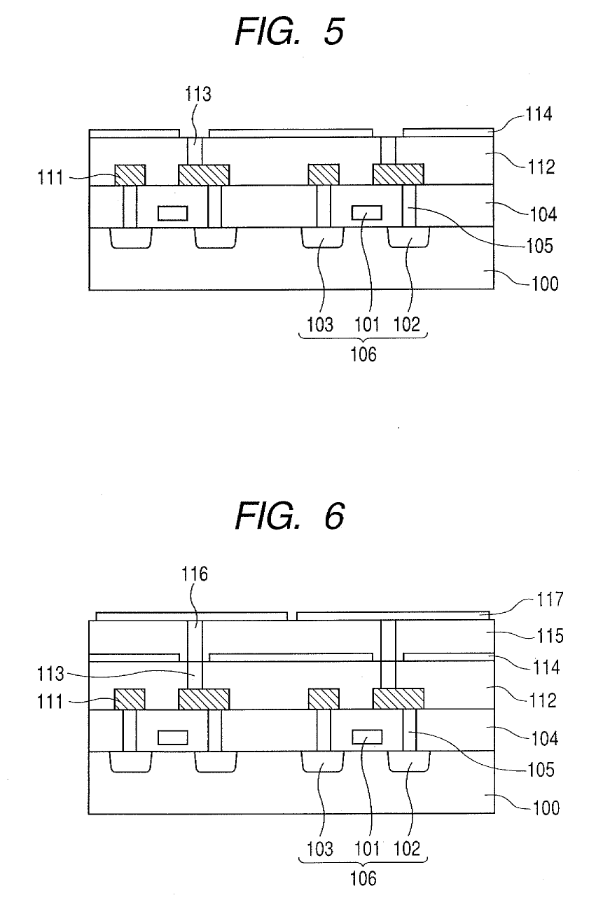

Then, as shown in FIG. 5, the second interlayer insulating film 112 is formed by plasma CVD or otherwise, and the second connecting holes 113 are bored by photolithography and dry etching. The second connecting holes 113 are formed by further performing a step of forming films of barrier metal, such as Ti, TiN or the like, and W and by a W etch-back step. Further, a metal film mainly composed of Ti, TiN, W. Al or the like was formed by sputtering and otherwise, followed by photolithography and dry etching to form the light shielding layer 114.

Next, as shown in FIG. 6, the third interlayer insulating film 115 is formed by a planarization step using by plasma CVD, CMP, resist etch-back or the like. Then, the third connecting holes 116 are bored by photolithography and dry etching. The third connecting holes 116 are formed by further performing a step of forming films of barrier metal, such as Ti, TiN or the like, and W and by a W etch-back step. Further, an aluminum film of pure aluminum or aluminum with addition of silicon or copper in a few weight % was formed by sputtering and otherwise, followed by photolithography and dry etching to form the pixel electrodes 117.

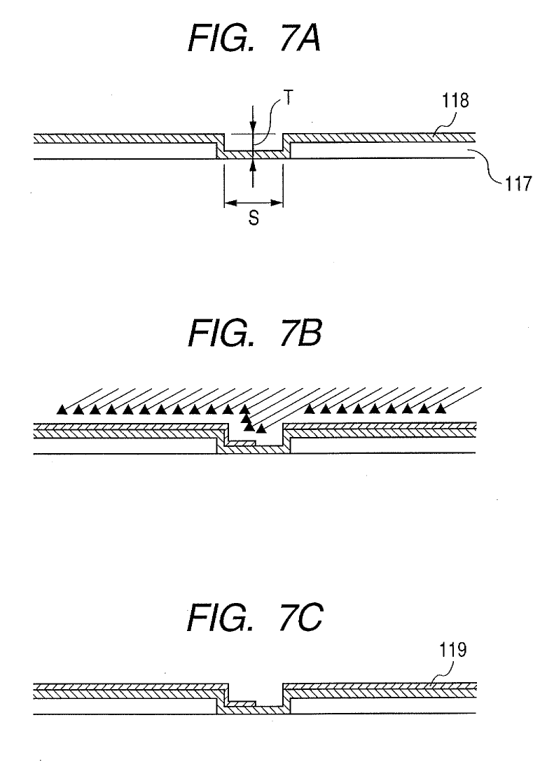

Next, the fabrication method to form the oblique vapor deposition film over the pixel electrodes is described with reference to FIGS. 7A through 7C.

First, as shown in FIG. 7A, the insulating film 118 is formed over the pixel electrodes 117. In this case, silicon oxide film of 10 nm in thickness was formed by plasma CVD.

Then, as shown in FIGS. 7B and 7C, the oblique vapor deposition film 119 is formed over the insulating film 118. Here, a silicon oxide film of 50 nm in thickness was vapor-deposited with an inclination of 60° to the normal direction of the substrate with an electron beam. The surface after deposition was asymmetric in film coverage under the influence of the oblique vapor deposition as shown in FIG. 7C.

The width S of the inter-pixel gap of the pixel electrodes and the step T of the pixel electrodes is defined here as illustrated in FIG. 7A. While the oblique vapor deposition film is deposited in a certain direction as illustrated, the proportion of the region in which the film is formed in the inter-pixel gap is determined by T/S. Thus, the smaller the T/S, the greater the proportion of the region in which the film is formed in the inter-pixel gap. For instance, if the inter-pixel gap is fixed, the smaller the step T of the pixel electrodes, the greater the proportion of the region in which the film is formed in the inter-pixel gap. Here, the film is formed at S=300 nm and T=100 nm.

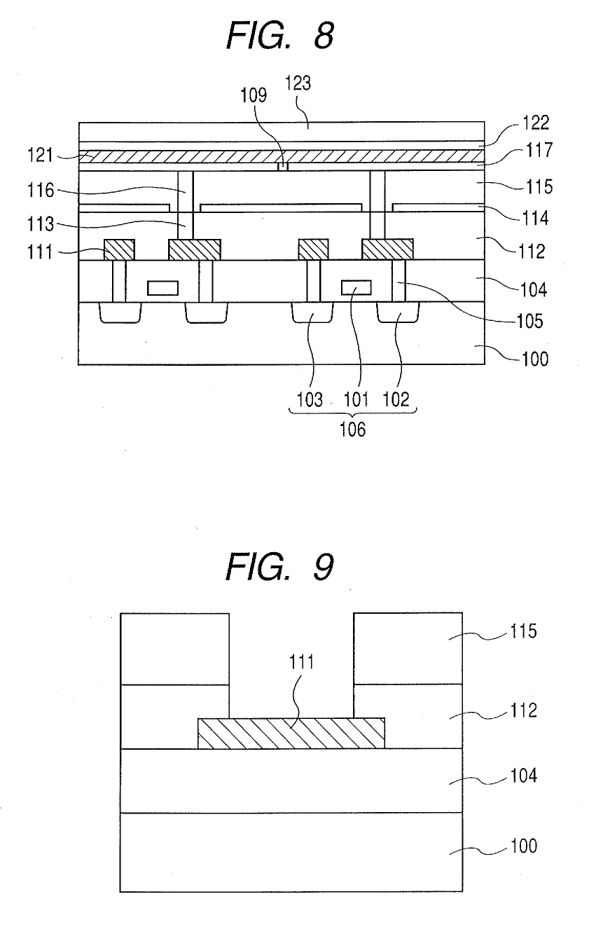

Then, as shown in FIG. 8, the active matrix substrate and the opposite substrate 123 having a oblique vapor deposition film over an opposite electrode 122 formed of a transparent electroconductive material such as an indium tin oxide (ITO) film are arranged opposing each other. Next, liquid crystals are implanted through a liquid crystal inlet to arrange the liquid crystal layer 121 between the active matrix substrate and the opposite substrate. Finally, the reflective liquid crystal element shown in FIG. 1 is fabricated by sealing the liquid crystal inlet.

Incidentally, according to the invention, the film thickness of the pixel electrodes which constitute the top electroconductive layer is kept as thin as 50 to 200 nm with a view to enhancing the surface planarity of the reflective liquid crystal element. Further, pad electrodes for electrical connection with outside are provided in the area of the silicon substrate 100 around the pixel region (the region between edges of the silicon substrate 100 and the pixel region). For this reason, if the pad electrodes were provided by the top electroconductive layer, such problems might occur at the time of packaging as a drop in wire boding strength or coming-off of the pad electrodes. With a view to steady manufacturing, therefore, pad electrodes which are bonded in at least one of the electroconductive layers below the pixel electrodes 117, which constitute the top electroconductive layer, are formed. A sectional view of the pad part of the reflective liquid crystal display element according to the invention is shown in FIG. 9.

As shown in FIG. 9, the second electroconductive layer 112 and the third electroconductive layer 113 are bored by dry etching or otherwise to the first electroconductive layer to provide the first electroconductive layer for the pad electrode. This enables stable wire bonding-resistance to be achieved. Although the first electroconductive layer is provided for pad electrodes in the configuration shown in FIG. 9, this is not the only possible arrangement, but any electroconductive layer below the pixel electrodes can serve the purpose. The second electroconductive layer may as well provide pad electrodes. Or a plurality of electroconductive layers below the pixel electrodes may be used instead.

According to the invention, by limiting the film thickness of the pixel electrodes to between 50 and 200 nm, the step of the pixel electrodes is reduced, and a reflective liquid crystal display element with secured orientation is formed without having to use a planarization process. By setting the relationship between the step T of the pixel electrodes and the width S of the gap between the pixel electrodes to be T/S<1, the disturbance of orientation can be further restrained.

Further according to the invention, reflective liquid crystal elements free from sticking (image memory phenomenon) can be provided as lower cost. The invention can also provide reflective liquid crystal elements free from sticking (image memory phenomenon) and stable in orientation. Also according to the invention, high contrast reflective liquid crystal elements free from sticking (image memory phenomenon) and stable in orientation can be provided.

### Second Exemplary Embodiment

In the first exemplary embodiment, the film coverage may made asymmetric by the influence of oblique vapor deposition to invite failure of oblique vapor deposition film formation in part of the inter-pixel region 109 as shown in FIG. 7C. If a part in which no oblique vapor deposition film is formed constitutes a large majority of the inter-pixel region 109, imperfect orientation of the liquid crystal layer may occur, which would invite a drop in contrast or some other trouble.

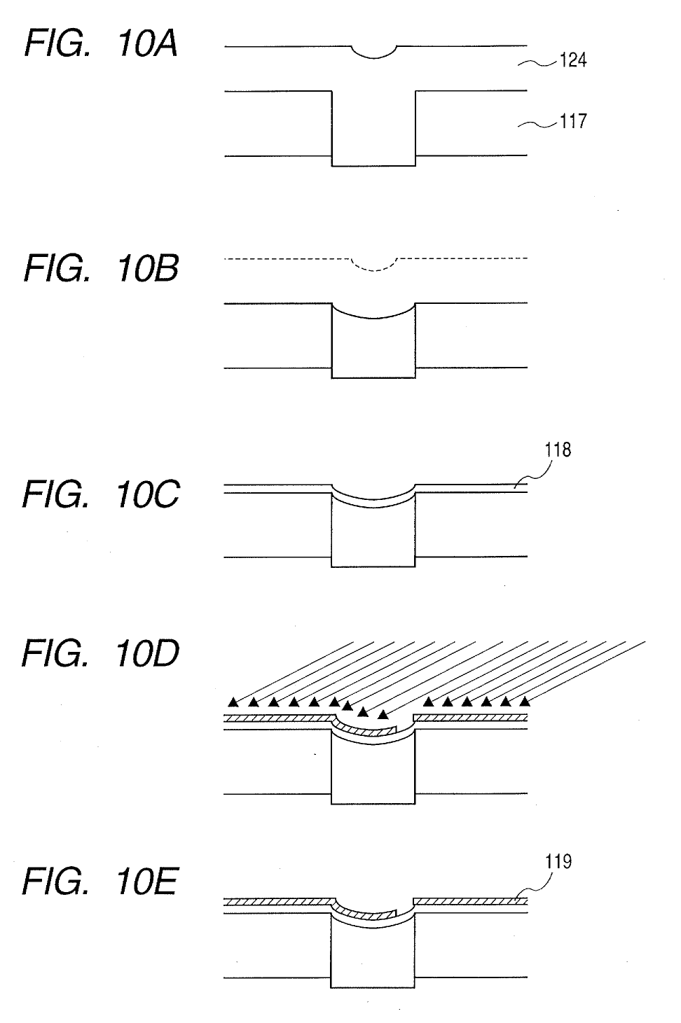

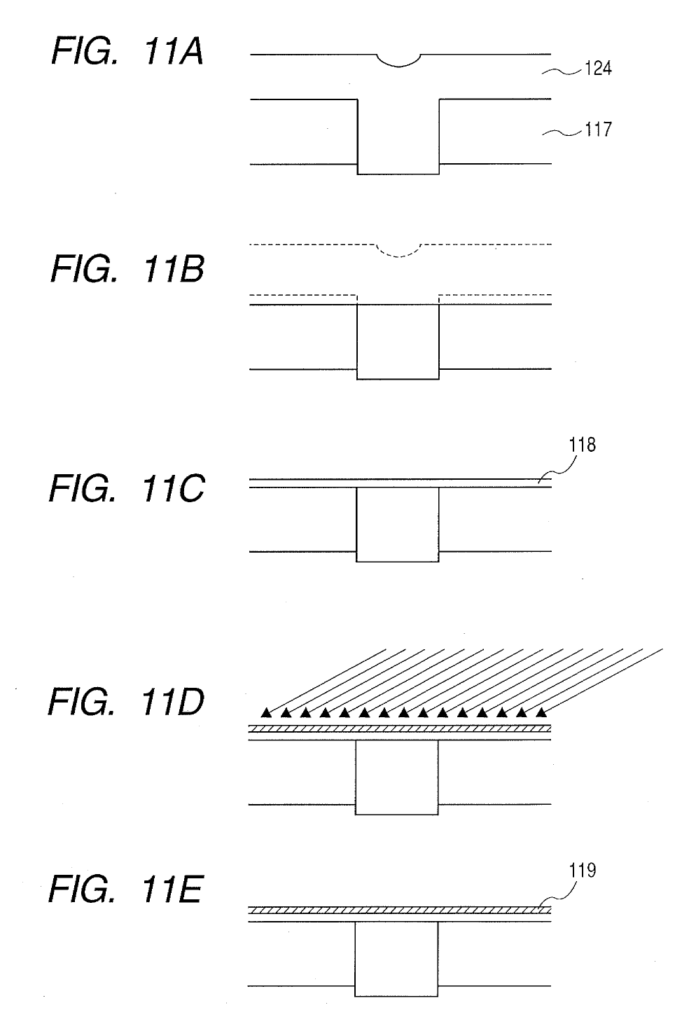

In this connection, an exemplary embodiment in which the region between pixel electrodes is planarized will be described with reference to FIGS. 10A through 10E. As shown in FIG. 10A, an embedding insulating film 124 is formed over the pixel electrodes 117.

Next, as shown in FIG. 10B, etching with gas such as CF_{4,}O₂ is performed to etch back the embedding insulating film 124 until the pixel electrodes 117 are exposed. Then, the insulating film 118 is formed as shown in FIG. 10C. Then, as shown in FIGS. 10D and 10E, the oblique vapor deposition film is formed. Here, a silicon oxide film of 50 nm in thickness is vapor-deposited at an inclination of 60° to the normal direction of the substrate with an electron beam.

This process enables even the inter-pixel region 109 to be almost wholly covered by the oblique vapor deposition film 119 and stable orientation of the liquid crystal layer to be secured.

### Third Exemplary Embodiment

In the second exemplary embodiment, stable orientation of the liquid crystal layer can be secured by enhancing the inter-pixel coverage of the oblique vapor deposition film as shown in FIG. 10E. However, when the embedding insulating film 124 is etched back to expose the pixel electrodes 117, the surface of the pixel electrodes may suffer etching damage. A possible consequence is the occurrence of fine unevenness on the surface of the pixel electrodes 117 and a resultant drop in reflectivity.

In view of this problem, another exemplary embodiment which permits inter-pixel planarization without sacrificing reflectivity will be described with reference to FIGS. 11A through 11E. As shown in FIG. 11A, the embedding insulating film 124 is formed over the pixel electrodes 117.

Next, as shown in FIG. 11B, part of the embedding insulating film 124 and the pixel electrodes 117 are polished. Then, the insulating film 118 is formed as shown in FIG. 11C. Next, as shown in FIGS. 11D and 11E, the oblique vapor deposition film is formed. Here, a silicon oxide film of 50 nm in thickness is vapor-deposited with an electron beam at an inclination of 60° to the normal direction of the substrate with an electron beam.

This process enables even the inter-pixel region 109 to be almost wholly covered by the oblique vapor deposition film 119 and stable orientation of the liquid crystal layer to be secured. Moreover, as the surface of the pixel electrodes is in a mirror finish, high reflectivity can be maintained, eventually enabling a high luminance display elements for projector use to be provided.

### Fourth Exemplary Embodiment

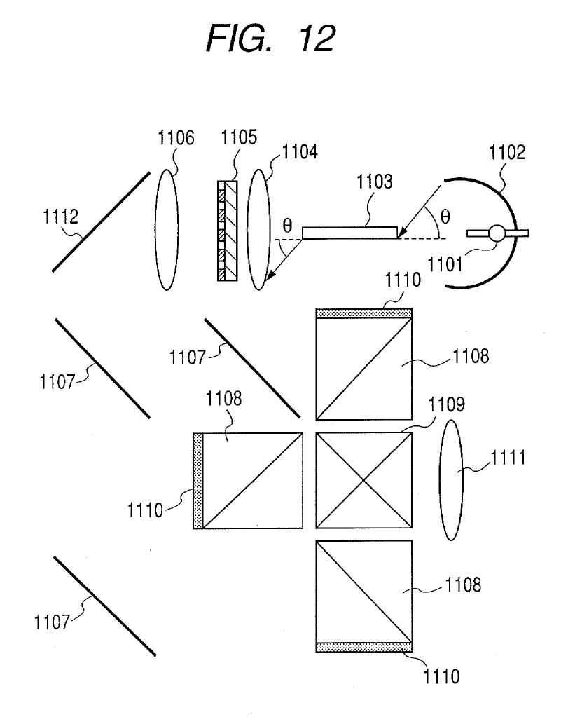

A liquid crystal projector system will be described with reference to FIG. 12. FIG. 12 shows an example of optical system for liquid crystal projectors

Reference numeral 1101 designates a lamp; 1102, a reflector; 1103, a rod integrator; 1104, a collimator lens; 1105, a polarizing converter; 1106, a relay lens; 1107, a dichroic mirror; 1108, a polarizing beam splitter; 1109, a cross prism; 1110, liquid crystal panels; 1111, a projection lens; and 1112, a total reflection mirror.

A luminous flux emitted from the lamp 1101 is reflected by the reflector 1102, and condensed onto the inlet to the integrator 1103. This reflector 1102 is an oval reflector, whose focuses are present in the light emitting part and the integrator inlet. The luminous flux having entered the integrator 1103 is reflected 0 to a few times within the integrator, and forms a secondary light source image at the integrator outlet. One of the methods of forming a secondary light source image is what uses a fly eye, but its description is dispensed with here. The luminous flux from the secondary light source is made a substantially parallel light beam through the collimator lens 1104, and comes incident on the polarizing beam splitter 1108 of the polarizing converter 1105. The P wave is reflected by the polarizing beam splitter 1105 and passes a λ/2 plate to become the S wave, the whole becoming the S wave, and comes incident on the relay lens 1106. The luminous flux is condensed by the relay lens 1106 onto panels. While the flux is being condensed onto the panels, a color separating system is configured of the color separating dichroic mirror 1107, a polarizing plate (not shown), the polarizing beam splitter 1108, the cross prism 1109 and so forth, and the S wave comes incident on three liquid crystal panels 1110. On the liquid crystal panels 1110, liquid crystal shutters control the voltage for each pixel according to the image. In a common form, the S wave is modulated into a oval polarized light beam (or a linear polarized light beam), to have its P wave component transmitted by the polarizing beam splitter 1108 and, after going through color synthesis by the cross prism 1109, to project the light from the projection lens 1111.

### Fifth Exemplary Embodiment

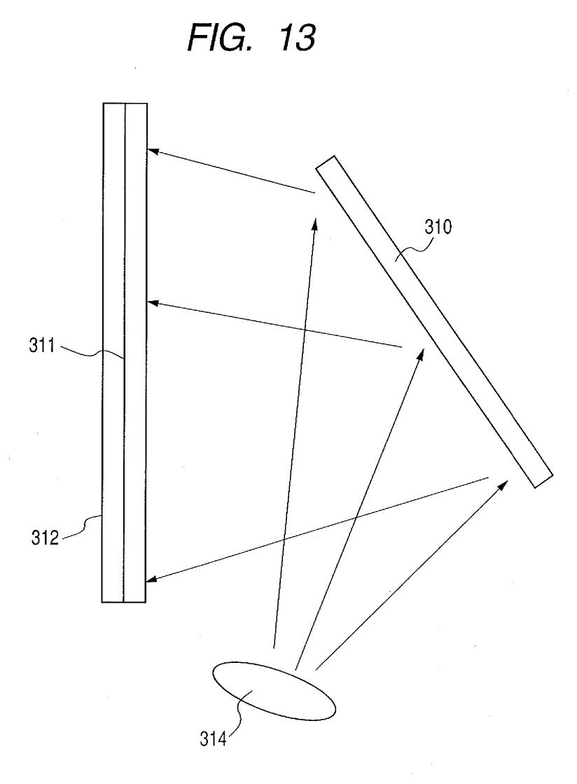

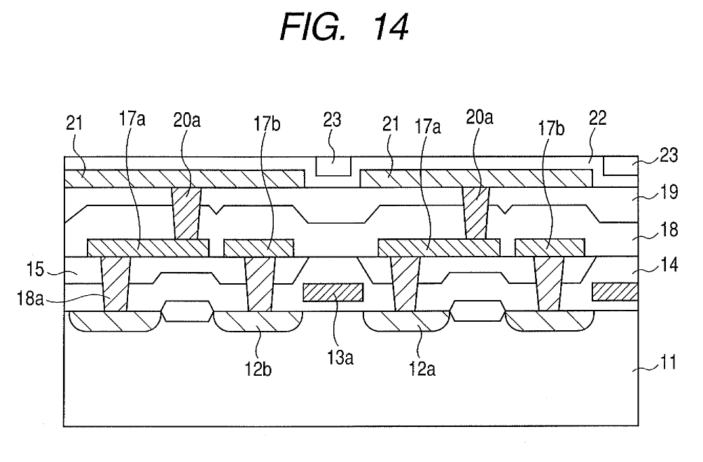

A liquid crystal projector apparatus of this exemplary embodiment, installed in a casing, can constitute a liquid crystal projector for projecting image light on a wall, a dedicated screen or the like. The liquid crystal projector apparatus of this exemplary embodiment can also be used for a rear projection apparatus, such as a rear projection television set. Thus, as shown in FIG. 13, the liquid crystal projector apparatus of this exemplary embodiment (only the projection lens is shown in this drawing) is arranged in the casing together with a reflective mirror 310, a Fresnel lens 311 and a lenticular lens 312. This arrangement realizes the configuration of a rear projection apparatus, such as a rear projection television set.

As shown in FIG. 13, light beams from a projection lens 314 of the liquid crystal projector apparatus is reflected by the reflective mirror 310 (or may be projected without being reflected by a reflective mirror as well), made parallel by the Fresnel lens 311 and scattered in a wide angle through the lenticular lens 312. Therefore, the liquid crystal projector apparatus of this exemplary embodiment is applicable to both the front projection type (which projects image light on a wall, a dedicated screen or the like) and the rear projection type (which projects image light on the rear plane of the screen to enable the viewer to see the light transmitted by the screen).

The present invention is applicable to liquid crystal display apparatuses, in particular to reflective liquid crystal displays and liquid crystal projectors.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-151778, filed May 31, 2006, and Japanese Patent Application No. 2007-140427, filed May 28, 2007, which are hereby incorporated by reference herein in their entirety.

What is claimed is:

1. An active matrix substrate for use in liquid crystal displays, comprising:
a lamination structure in which a plurality of interlayer insulating films and a plurality of electroconductive layers are alternately stacked, wherein a top layer among the plurality of interlayer insulating films is planarized; and
a pixel region having a plurality of pixels arranged over the top layer of the interlayer insulating films, wherein the plurality of pixel electrodes have a gap therebetween;
wherein the film thickness of the pixel electrodes is not less than 50 nm but not more than 200 nm, and the distance T between the surface of the pixel electrodes and the surface of the gap between the pixel electrodes is smaller than a width S of the gap between the pixel electrodes.

2. The active matrix substrate according to claim 1, further comprising an insulating film arranged over the plurality of pixel electrode, and the thickness of the insulating film is not less than 5 nm but not more than 40 nm.

3. The active matrix substrate according to claim 2, wherein the material of the insulating film is at least one of silicon oxide, silicon nitride, silicon oxynitride and alumina (Al₂O₃).

4. The active matrix substrate according to claim 2, further comprising an oblique vapor deposition film arranged over the insulating film.

5. The active matrix substrate according to claim 4, wherein the oblique vapor deposition film is formed of at least one of silicon oxide, silicon nitride, silicon oxynitride and alumina (Al₂O₃).

6. The active matrix substrate according to claim 1, further comprising pad electrodes disposed in a region around the pixel region, wherein the pad electrodes is provided by at least one of the plurality of electroconductive layers.

7. A liquid crystal display comprising:
the active matrix substrate according to claim 1;
an opposite substrate having an opposite electrode; and
a liquid crystal layer arranged between the active matrix substrate and the opposite substrate.

8. The liquid crystal display according to claim 7, wherein the pixel electrodes are formed of a light reflecting metallic material, the opposite electrode is formed of a light transmitting electroconductive material, and the oblique vapor deposition film is disposed above the plurality of pixel electrodes.

9. A liquid crystal projector comprising the liquid crystal display according to claim 7.

10. A rear projection apparatus comprising:
the liquid crystal projector according to claim 9; and
a screen having a rear plane on which an image light from the liquid crystal projector apparatus is to be projected.
